(19) United States
(12) Patent Application Publication
(10) Pub. No.: US 2002/0156193 A1
(43) Pub. Date: Oct. 24, 2002

(54) Composition and films thereof

(76) Inventors: Li-Min Tau, Lake Jackson, TX (US); Wendy D. Hoenig, Lake Jackson, TX (US); Lisa S. Madenjian, Lake Jackson, TX (US); Pak-Wing S. Chum, Lake Jackson, TX (US); John Kaarto, Verdun (CA); Johan A. Thoen, Terneuzen (NL)

Correspondence Address: THE DOW CHEMICAL COMPANY, INTELLECTUAL PROPERTY SECTION, 2301 N BRAZOSPORT BLVD, FREEPORT, TX, 77541-3257, US

(21) Appl. No.: 10/121,985

(22) Filed: Apr. 12, 2002

Related U.S. Application Data
(63) Continuation of application No. 09/602,485, filed on Jun. 23, 2000, now abandoned.
(60) Provisional application No. 60/140,776, filed on Jun. 24, 1999.
(60) Provisional application No. 60/164,221, filed on Nov. 9, 1999.

(51) Int. Cl. C08F 8/00

(52) U.S. Cl. 525/191

(57) ABSTRACT

The present invention includes a composition comprising (a) at least one propylene polymer coupled by reaction with a coupling amount of poly(sulfonyl azide) sufficient to increase the melt strength of the propylene polymer before coupling at least about 1.5 fold as compared with the resulting coupled propylene polymer; and (b) at least one ethylene polymer wherein the ethylene polymer is present in an amount sufficient to improve film mechanical properties of tear resistance in either the machine direction (MD) and cross direction (CD) as measured by the Elmendorf Tear method (ASTM D-1922) or dart impact strength as measured by the procedure of ASTM D-1709 or a modified method thereof in which the height from which the dart is dropped is decreased from 26″ to 10.5″ (0.66 m to 0.27 m) as compared with a film formed in the same manner using the coupled propylene polymer of (a) alone. Preferably, the propylene polymer is present in an amount of greater than about 50 weight percent of the resulting composition and the ethylene polymer is present in an amount of from about 5 to about 49 weight percent. The invention also includes any blown film blown from a composition of the invention, particularly when blown on a high or low stalk extruder or coextruded as well as the process of blowing such a film. Further, the invention includes any article comprising a composition of the invention or comprising a film of the invention. Particular embodiments are those articles including an institutional liner, consumer liner, heavy duty shipping sack, produce bag, batch inclusion bag, pouch, grocery bag, merchandise bag, packaging, cereal liner, soft paper overwrap, multi-wall bag, lamination or combination thereof, including multi-wall or multilayer configurations thereof. Further, the invention includes the use of a composition of the invention for making a blown film.

This application claims the benefit of U.S. Provisional Application Nos. 60/140,776, filed Jun. 24, 1999 and 60/164,221, filed Nov. 9, 1999.

This invention relates to polyolefins, more particularly to propylene polymer compositions.

### BACKGROUND

Currently, blown films are made predominantly from ethylene polymers. There are references to blowing films of propylene polymers, but none are observed to be commercially successful. The low melt strength of propylene polymers inhibits production of blown film with such polymers at commercially feasible rates on standard equipment.

Scheve et al. in U.S. Pat. No. 5,519,785 disclosed the use of polypropylenes having a branching index less than one and having a strain hardening elongational viscosity to blow certain films. The polymers were treated with radiation under specified conditions in a multistep process which involves specialized equipment in steps after polymerization. Such a process is multi step, difficult and preferably avoided.

Giacobbe and Pufka in U.S. Pat. No. 5,641,848 disclose making blown films from a propylene polymer material of broad molecular weight distribution (MWD of about 4-60), a melt flow rate of about 0.5 to 50 dg/min. and xylene insolubles (at 25° C.) of greater than or equal to 94 percent, said propylene polymer material selected from a broad molecular weight distribution propylene homopolymer and an ethylene propylene rubber impact modified broad molecular weight homopolymer. But this blend forms blown films at rates lower than those used commercially for polyethylene blown films.

In some instances, blowing films of polypropylene has been achieved by coextruding a polypropylene with another polymer. For instance, Nicola disclosed in DE 19650673 the use of a rubber modified polypropylene layer between polypropylene layers. Similarly, Landoni in EP 595252 disclosed the use of linear low density polyethylene or linear medium density polyethylene, optionally with added hydrogenated hydrocarbon resins or other resins or low molecular weight polyethylene or polypropylene waxes between external layers of polypropylene. In EP 474376, Schirmer et al. disclose the use of an ethylene vinyl acetate copolymer (EVA), very low density polyethylene (VLDPE) or ethylene alpha olefin copolymer with a broad molecular weight distribution with a polypropylene layer and a sealable layer. It would be desirable to use monolayer films to provide the desired performance.

It would therefore be desirable to have a propylene polymer composition with sufficient melt strength to maintain a stable bubble for blown film manufacture on commercially available equipment, preferably that equipment available for the blowing of ethylene polymer compositions, more preferably both air and water quenched blown film equipment in both high and low stalk configurations, that is equipment commonly used for high density and low density polyethylenes, respectively. The term “stalk” is used to designate the neck height of a bubble of polymer being blown into film. To achieve this end, a propylene polymer composition would advantageously have a melt strength that is higher than about 10, preferably between 10-100 cN, more preferably between 20-80 cN, and most preferably between 25-75 cN (measured at 190° C.). Further, it is desirable that the resulting film shows at least a mechanical properties balance.

Rheology modification of the propylene polymers through reaction with coupling agents has now been found to improve the melt strength of the propylene polymers sufficiently to permit production of blown films with the rheology modified propylene polymers at commercially acceptable rates.

As used herein, the term “rheology modification” means change in the resistance of the molten polymer to flow. The resistance of polymer melts to flow is indicated by (1) the tensile stress growth coefficient and (2) the dynamic shear viscosity coefficient. The tensile stress growth coefficient η_{E+} is measured during start-up of uniaxial extensional flow by means within the skill in the art such as is described by J. Meissner in Proc. XIIth International Congress on Rheology, Quebec, Canada, August 1996, pages 7-10 and by J. Meissner and J. Hostettler, Rheol. Acta, 33, 1-21 (1994). The dynamic shear viscosity coefficient is measured with small-amplitude sinusoidal shear flow experiments by means within the skill in the art such as described by R. Hingmann and B. L. Marczinke, J. Rheol. 38(3), 573-87, 1994.

### SUMMARY OF THE INVENTION

In one embodiment the present invention includes a composition comprising (a) at least one propylene polymer coupled by reaction with a coupling amount of poly(sulfonyl azide) sufficient to increase the melt strength of the coupled propylene polymer to at least about 1.5, preferably 3, fold that of the propylene polymer before coupling; and (b) at least one ethylene polymer, wherein the ethylene polymer is present in an amount sufficient to improve film mechanical properties (of a blown film of the composition) of tear resistance in either the machine direction (MD) or cross direction (CD) as measured by the Elmendorf Tear method (ASTM D-1922) or dart impact strength as measured by the procedures of ASTM D-1709 or a modified method thereof in which the height from which the dart is dropped is decreased from 26″ to 10.5″ (0.66 m to 0.27 m) as compared with a film formed in the same manner using the coupled propylene polymer of (a) alone. Preferably, the propylene polymer is present in an amount of greater than about 50 weight percent of the resulting composition and the ethylene polymer is present in an amount of from about 5 to about 49 weight percent. The invention also includes any film blown from a composition of the invention, particularly when blown on a high or low stalk extruder or coextruded as well as the process of blowing such a film. Further, the invention includes any article comprising a composition of the invention or comprising a film of the invention.

In a second embodiment the invention is a coextruded film comprising (a) at least one layer comprising at least one coupled propylene polymer coupled by reaction with a poly(sulfonyl azide) to increase the melt strength of the coupled propylene polymer to at least about 1.5 fold that of the propylene polymer before coupling; and (b) at least one layer comprising at least one ethylene polymer.

Particular embodiments are those articles including an institutional liner, consumer liner, heavy duty shipping sack, produce bag, batch inclusion bag, pouch, grocery bag, merchandise bag, packaging, cereal liner, soft paper overwrap, multi-wall bag, lamination or combination thereof, including multi-wall or multilayer configurations thereof. Further, the invention includes the use of a composition of the invention for making a blown film.

### BRIEF DESCRIPTION OF THE FIGURES

FIG. 1 is a diagram showing the heat seal strength versus temperature of 0.4 mil and 0.7 mil films made from coupled and uncoupled random propylene copolymers.

FIG. 2 is a bar chart showing the back pressure present during the processing of a coupled propylene impact copolymer and a high molecular weight high density polyethylene polymer on a linear low density polyethylene blown film processing line.

FIG. 3 is a bar chart showing the maximum output rates for several polymers on a linear low density polyethylene blown film processing line.

### DETAILED DESCRIPTION OF THE INVENTION

As used herein, “coupling” refers to modifying the rheology of a polymer by reacting the polymer with a suitable coupling agent. A “coupled polymer” is a rheology modified polymer resulting from a coupling reaction. A coupled polymer is characterized by an increase in melt strength of at least 25 % and a decrease in melt flow rate (MFR), compared to the polymer before coupling. A coupled polymer differs from a crosslinked polymer in that the coupled polymer is thermoplastic and has a low gel level. In contrast, crosslinking (otherwise known as “vulcanization”) results in a thermoset polymer characterized by high gel levels.

Crosslinking is evidenced by gel formation which is measured in the case of polypropylene by xylene insolubility, or in the case of films by optically evident gels in a film, for instance as analyzed by a laser gel counter commercially available from Optical Control System, Inc. under the trade designation FS-3

The term “a coupling amount” of poly(sulfonyl azide) is used herein to designate that amount of poly(sulfonyl azide) effective to result in a measurable increase in melt strength of the polymer it reacts with such that the desired or predetermined amount of modification is realized.

“Melt Strength” is measured by using a capillary rheometer fitted with a 2.1 mm diameter, 20:1 die with an entrance angle of approximately 45 degrees. After equilibrating the samples at 190° C. for 10 minutes, the piston is run at a speed of 1 inch/minute. The standard test temperature is 190° C. The sample is drawn uniaxially to a set of accelerating nips located 100 mm below the die with an acceleration of 2.4 mm/sec². The required tensile force is recorded as a function of the take-up speed of the nip rolls. The maximum tensile force attained during the test is defined as the melt strength. In the case of polymer melt exhibiting draw resonance, the tensile force before the onset of draw resonance was taken as melt strength. The melt strength is recorded in centiNewtons.

The term “mechanical properties balance” is used to mean good toughness as measured by tear strength greater than 5 g/mil in machine direction (MD) and 20 g/mil in cross direction (CD).

A propylene polymer (also called polypropylene) is any polymer comprising greater than sixty (60) weight percent, preferably, greater than sixty five (65) weight percent —CHCH₃CH₂— repeating units as derived from a propylene monomer. Propylene polymers include propylene homopolymer as well as random and impact copolymers of propylene. Such polymers include terpolymers, tetrapolymers and higher order polymers of ethylene, propylene and other olefins optionally dienes.

An ethylene polymer is any polymer comprising greater than fifty weight percent —CH₂CH₂— repeating units as derived from an ethylene monomer. Ethylene polymers include homopolymers of ethylene as well as random and block copolymers of ethylene. Such polymers include terpolymers, tetrapolymers and higher order polymers of ethylene, propylene and other olefins optionally dienes.

### Propylene Polymers

This invention involves compositions of at least one propylene polymer which is coupled using a poly(sulfonyl azide) and at least one ethylene polymer.

In either propylene copolymers or ethylene copolymers, the propylene or ethylene, respectively, is suitably copolymerized with one or more monomers copolymerizable therewith, but preferably with at least one other olefin or alpha olefin. Olefins include ethylene and alpha olefins, which include propylene, 1-butene, 1-pentene, 1-hexene. 1-octene, 1-nonene, 1-decene, 1-unidecene, 1-dodecene and the like as well as 4-methyl-1-pentene, 4-methyl-1-hexane, 5-methyl-1-hexane, vinylcyclohexane, styrene and the like. Preferred olefins and alpha olefins for copolymerization with propylene include ethylene, butylene, and other higher alpha olefins, that is alpha olefins having at least 3 carbon atoms, more preferably ethylene or butylene, and higher alpha olefins, most preferably ethylene. Preferred alpha olefins for copolymerization with ethylene include propylene, butene, pentene, hexene, heptene, and octene, more preferably hexene or octene. most preferably octene.

The polymer starting materials are suitably of any molecular weight distribution (MWD). MWD is calculated as the ratio M_{w}/Mₙ, where M_{w} is the weight average molecular weight and Mₙ is the number average molecular weight. Those skilled in the art are aware that polymers having a MWD less than about 3 are conveniently made using a metallocene or constrained geometry catalyst (especially in the case of ethylene polymers) or using electron donor compounds with Ziegler Natta catalysts (especially in the case of polypropylene). In the practice of the invention, the MWD is preferably at least about 2 and more preferably up to about 8, most preferably up to about 5.

Polyolefins are formed by means within the skill in the art. The alpha olefin monomers and optionally other addition polymerizable monomers are polymerized under conditions within the skill in the art, for instance as disclosed by Galli, et al., Angew. Macromol. Chem., Vol. 120, p. 73 (1984), or by E. P. Moore, Propylene Handbook, Hanser, N.Y., 1996 pages 15-45, 74-111, U.S. Pat. Nos. 3,645,992; 3,687,920; 3,893,989; 3,914,342; 4,003,712; 4,076,698; 4,113,802; 5,272,236; 5,278272; 5,747,594; 5,844,045 and 5,869,575. These U.S. patents are incorporated herein by reference.

The comonomers or combination of comonomers is used in any relative quantities within the definitions of the polymers. For propylene polymers, the comonomer content is preferably less than about 35, more preferably 2-30, most preferably 5-20 weight percent.

The propylene polymers are preferably stereoregular (i.e. syndiotactic or isotactic), more preferably isotactic, most preferably having an isotacticity as measured by C¹³NMR of at least about 50 percent.

The propylene polymer melt flow rate is measured by ASTM D 1238L at 230° C./2.16 kg. The melt flow rate is preferably at least about 0.1, more preferably at least about 0.2 g/10 min. It is preferably up to about 20, more preferably up to about 10, most preferably up to about 4 g/10 min. to achieve good processability and mechanical properties balance. One recognizes good processability by high output rates (>6 pounds per hour per inch of die circumference (0.298 g/s/cm)).

The propylene polymer is advantageously a homopolymer for purposes of ready availability of starting material and resulting competitive pricing. Random and impact copolymers are preferred for compatibility of propylene and ethylene polymers. Higher compatibility results in improved film physical and mechanical properties such as tear and dart as compared with the base polypropylene resin of the copolymers, impact copolymers are more preferred, again, because they are very compatible with ethylene copolymers. Random copolymers are preferred when film optical properties (that is clarity and haze) are important.

Impact propylene copolymers are commercially available and are well within the skill in the art, for instance, as described by E. P. Moore, Jr in Polypropylene Handbook, Hanser Publishers, 1996, page 220 and U.S. Pat. Nos. 3,893,989 and 4,113,802. The term “impact copolymer” is used herein to refer to heterophasic propylene copolymers where polypropylene is the continuous phase and an elastomeric phase is uniformly dispersed therein. The impact copolymers result from an in-reactor process rather than physical blending. Usually the impact copolymers are formed in a dual or multi-stage process, which optionally involves a single reactor with at least two process stages taking place therein, or optionally multiple reactors. Advantageously, the impact copolymers have at least about 5 weight percent, preferably at least about 10, preferably up to about 40, more preferably up to about 25 weight percent, and most preferably up to about 20 weight percent ethylene. Illustrative impact copolymer propylene polymers include those available from The Dow Chemical Company under the trade designations INSPiRE C 104-01, INSPiRE C 105-02, DC-111, and INSPiRE C 107-04, propylene impact copolymers having melt flow rates of 1, 2, 0.8, and 4 g/10 min, respectively, under a weight of 2.16 kg at a temperature of 230° C. and flexural (flex) modulus as measured according to the procedures of ASTM D 790A of 180,000, 140.000, 166,800. and 170,000 psi (1.241,056; 965,266; 1,150,000, and 1,172,109 kPa. respectively).

### Coupling Agents

In the practice of the invention, at least one propylene polymer resin is reacted with a chain coupling agent which is a poly(sulfonyl)azide. When the poly(sulfonyl)azide reacts with the propylene polymer resin, at least two separate propylene polymer chains are advantageously joined and the molecular weight of the polymer chain is increased. In the preferred case when the poly(sulfonyl azide) is a bis(sulfonyl azide) (hereinafter “BSA”), two propylene polymer chains are advantageously joined.

The poly(sulfonyl azide) is any compound having at least two sulfonyl azide groups (—SO₂N₃) reactive with the propylene polymer. Preferably the poly(sulfonyl azide)s have a structure X—R—X wherein each X is SO₂N₃ and R represents an unsubstituted or inertly substituted hydrocarbyl, hydrocarbyl ether or silicon-containing group, preferably having sufficient carbon, oxygen or silicon, preferably carbon, atoms to separate the sulfonyl azide groups sufficiently to permit a facile reaction between the propylene polymer and the sulfonyl azide, more preferably at least 1, more preferably at least 2, most preferably at least 3 carbon, oxygen or silicon, preferably carbon, atoms between functional groups. While there is no critical limit to the length of R, each R advantageously has at least one carbon or silicon atom between X's and preferably has less than about 50, more preferably less than about 20, most preferably less than about 15 carbon, oxygen or silicon atoms.

Silicon containing groups include silanes and siloxanes, preferably siloxanes. The term inertly substituted refers to substitution with atoms or groups which do not undesirably interfere, at the coupling reaction conditions, with the desired reaction(s) or desired properties of the resulting coupled polymers. Such groups include fluorine. aliphatic or aromatic ether, siloxane as well as sulfonyl azide groups when more than two propylene polymer chains are to be joined. R is suitably aryl, alkyl, aryl alkaryl, arylalkyl silane, siloxane or heterocyclic, groups and other groups which are inert and separate the sulfonyl azide groups as described. More preferably R includes at least one aryl group between the sulfonyl groups, most preferably at least two aryl groups (such as when R is 4,4′ diphenylether or 4,4′-biphenyl). When R is one aryl group, it is preferred that the group have more than one ring, as in the case of naphthylene bis(sulfonyl azides). Poly(sulfonyl)azides include such compounds as 1,5-pentane bis(sulfonylazide), 1,8-octane bis(sulfonyl azide), 1,10-decane bis(sulfonyl azide), 1,10-octadecane bis(sulfonyl azide), 1-octyl-2,4,6-benzene tris(sulfonyl azide), 4,4′-diphenyl ether bis(sulfonyl azide), 1,6-bis(4′-sulfonazidophenyl)hexane, 2.7-naphthalene bis(sulfonyl azide), and mixed sulfonyl azides of chlorinated aliphatic hydrocarbons containing an average of from 1 to 8 chlorine atoms and from about 2 to 5 sulfonyl azide groups per molecule, and mixtures thereof. Preferred poly(sulfonyl azide)s include oxy-bis(4-sulfonylazidobenzene), 2,7-naphthalene bis(sulfonyl azido), 4,4′-bis(sulfonyl azido)biphenyl, 4,4′-diphenyl ether bis(sulfonyl azide) and bis(4-sulfonyl azidophenyl)methane, and mixtures thereof.

Sulfonyl azides are commercially available or are conveniently prepared by the reaction of sodium azide with the corresponding sulfonyl chloride, although oxidation of sulfonyl hydazines with various reagents (nitrous acid, dinitrogen tetroxide, nitrosonium tetrafluoroborate) has been used.

The subject matter of this invention is not dependent on the reaction mechanisms. The following discussion regarding the coupling reaction mechanism provides the inventors current theories but is not intended to limit the scope of this invention. Sulfonyl azides decompose in several ways, but for the practice of the invention, the reactive species, believed to be the singlet nitrene, as evidenced by insertion into C—H bonds is desired. Thermal decomposition is reported to give an intermediate singlet sulfonyl nitrene, which will react readily by insertion into carbon-hydrogen bonds. The high temperatures necessary for efficient formation of the sulfonyl nitrene is usually greater than about 150° C. Sulfonyl azides also form another intermediate believed to be a triplet nitrene under appropriate conditions, such as temperatures in excess of about 250° C. This intermediate leads to chain scission and, therefore, is preferably avoided in the practice of this invention.

The poly(sulfonyl azide) is preferably at least partially mixed with the propylene polymer before the resulting mixture is heated to the peak decomposition temperature of the poly(sulfonyl azide). By peak decomposition temperature of the poly(sulfonyl azide) is meant that temperature at which the azide converts to the sulfonyl nitrene, eliminating nitrogen and more heat in the process. Specifically the peak decomposition temperature, as determined by differential scanning calorimetry (DSC). For instance, a differential scanning calorimeter (DSC) thermogram of the bis (sulfonyl azide) of diphenyl oxide shows a no change in the heat flow until a sharp endothermic melting peak is observed at 100° C. The baseline is flat again (no heat flow) until a broad exothermic peak is observed that begins about 150° C., peaks at 185° C. (referred to herein as the peak decomposition temperature) and is complete by 210° C. The total amount of energy released due to decomposition of the sulfonyl azide groups is about 1500 Joules/gram. The peak decomposition temperature is advantageously greater than about 150° C., preferably greater than about 160° C., more preferably greater than about 180° C.

Those skilled in the art recognize that reactivity, the poly(sulfonyl)azide and the desired or predetermined amount of chain coupling determine the amount of poly(sulfonyl)azide to be used. In the compositions of the invention, the amount of coupling desirable is optionally determined from the desired melt strength in the coupled propylene polymer. The melt strength of the coupled propylene polymer is advantageously sufficient for the propylene polymer/ethylene polymer blend to form and maintain a sufficiently stable bubble on film blowing equipment to run at commercial output rates. Preferably, the melt strength of the coupled propylene polymer is at least about 5, more preferably at least about 10 cN. To avoid blown film bubble instabilities, the melt strength is preferably up to about 100, more preferably up to about 75 cN. Determining the amount of poly(sulfonyl azide) that gives this result is within the skill in the art. The amount is preferably at least about 50 parts per million by weight of the propylene polymer (ppm), more preferably at least about 100 ppm, most preferably at least about 150 ppm and, in some instances, preferably at least about 200 ppm. In the practice of the invention, formation of crosslinked networks to an extent that would result in intractable propylene polymer is to be avoided; therefore, poly(sulfonyl azide) is preferably limited to that amount which results in chain coupled or rheology modified (but not substantially crosslinked) propylene polymer, preferably less than about 1000 ppm, more preferably less than about 600 ppm, most preferably less than about 500 ppm poly(sulfonyl azide) based on the total weight of propylene polymer, preferably polypropylene or polypropylene/ethylene copolymer blend. Substantial crosslinking is characterized by the presence of gels of sufficient size or weight precentage such that the processing of the film is detrimentally affected. Such detrimental effects include output reduction; discontinuity of the film; increased backpressure; and/or, partial die plugging.

### Preparation of Modified Polypropylene

The propylene polymer(s) and coupling agent are suitably combined in any manner which results in desired reaction thereof, preferably by mixing the coupling agent with the polymer under conditions which allow sufficient mixing before or during reaction to avoid unnecessary or undesirably uneven amounts of localized reaction. An undesirable amount is an amount which interferes with the purpose of the final product. Any mixing equipment is suitably used with the invention, preferably equipment which provides sufficient mixing and temperature control in the same equipment, but advantageously practice of this embodiment takes place in such devices as an extruder, melt mixer, pump conveyor or a polymer mixing devise such as a Brabender melt mixer. While it is within the scope of this embodiment that the reaction take place in a solvent or other medium, it is preferred that the reaction be in a bulk phase to avoid later steps for removal of the solvent or other medium. In a preferred embodiment the process of the present invention takes place in a single vessel, that is mixing of the coupling agent and polymer takes place in the same vessel as heating to the decomposition temperature of the coupling agent. The vessel is most preferably a twin-screw extruder, but preferably a single-screw extruder or advantageously a melt mixer, including a batch mixer. The reaction vessel more preferably has at least two zones of different temperatures into which a reaction mixture would pass.

In the most preferred embodiment, the propylene polymer and the coupling agent are physically mixed at a temperature which is low enough to minimize the reaction between the coupling agent and the polymer. Such physical mixing can occur in any equipment, such as V-blenders, ribbon or paddle blenders, tumbling drums, or extruders, which will mix the coupling agent and the propylene polymer. The term extruder is used for its broadest meaning to include such devices as a device which extrudes pellets as well as an extruder which produces the extrudate for forming into articles, such as a film.

Preferably, this physical mixing occurs in the early stages of an extruder, most preferably a twin screw extruder. In particular, this embodiment may be practiced by simultaneously introducing the propylene polymer resin and the coupling agent into the feed section of an extruder. The extruder is configured to have a first section that physically mixes and conveys the coupling agent and polymer in a manner that minimizes the reaction between the coupling agent and the polymer. The melt stream temperature(s) in the first section are preferably less than about 180° C., more preferably less than about 170° C., most preferably less than about 140° C., and in some instances less than about 130° C., preferably less than about 120° C. The conveying first section is followed by at least a second section where the coupling agent and polymer are rapidly further mixed and sufficient heat is added to cause significant reaction between the coupling agent and polymer. Preferably, the melt stream temperature(s) in the second section are from about 160 C. to about 250 C., more preferably from about 200 C. to about 250° C. in order to obtain sufficient reaction between the coupling agent (poly(sulfonyl azide)) and the propylene polymer. Where degradation of the propylene polymer is of a particular concern, the melt stream temperature is preferably from about 200 C. to about 230 C.

In the description of this invention, when temperatures are described in terms of the stream temperatures, that is, temperatures inside the polymer stream or polymer melt rather than the temperatures of the equipment, which are understood by those skilled in the art to be likely to be lower or higher than stream temperatures because of imperfect heat transfer into the polymer or induced shear heating of the polymer. Those skilled in the art can determine the relationship between stream temperature and equipment or gage temperature of particular equipment without undue experimentation. It is known in the art that the polymer melt (stream) temperature is advantageously close to the machine set temperature in the initial zones of an extruder, but the polymer melt (stream) temperature can often be greater than the machine set temperatures in the latter zones of the extruder as it approaches the exit die of the extruder due to mechanically induced shear heating.

In another embodiment, the mixing is preferably attained with the polymer in a molten or at least partially melted state, that is, above the softening temperature of the polymer, or in a dissolved or finely dispersed condition rather than in a solid mass or particulate form. Melt phase mixing is advantageous for forming a substantially uniform admixture of coupling agent and polymer before exposure to conditions in which a significant amount of chain coupling takes place. Conveniently for this embodiment, the formation of a substantially uniform admixture occurs along a temperature profile within equipment such as an extruder. The first zone is advantageously at a temperature at least the softening temperature of the polymer(s) and preferably less than the decomposition temperature of the coupling agent s and the second zone being at a temperature sufficient for decomposition of the coupling agent. Especially in the case of propylene polymers, most preferably the propylene polymer(s) and coupling agent are exposed to a profile of melt stream temperatures ranging from about 160° C. to about 250° C.

Those skilled in the art recognize that a polymer, or mixture thereof, typically melts over a range of temperatures rather than melting sharply at one temperature. For the practice of this embodiment, it is sufficient that the polymer be in a partially melted state. For convenience, the temperature of this degree of melting can be approximated from the differential scanning calorimeter (DSC) curve of the polymer or mixture thereof to be treated.

Conveniently, when there is a melt extrusion step between production of the polymer and its use, at least one step of the process of the invention takes place in the melt extrusion step. The heat produced during the extrusion step provides the energy necessary to cause the reaction between the coupling agent and the target polymer.

For all embodiments, a temperature of at least the decomposition temperature of the coupling agent is preferably maintained for a time sufficient to result in decomposition of at least sufficient coupling agent to avoid later undesirable reaction, preferably at least about 80, more preferably at least about 90, most preferably at least about 95 weight percent of the coupling agent is reacted. Those skilled in the art realize that this time is dependent on whether the temperature is one at which the coupling agent slowly decomposes or one at which it very rapidly decomposes. Preferably, the time will be at least about 5 seconds, more preferably at least about 10 seconds to avoid unreacted coupling agent, and subsequent undesirable reactions, or to avoid the need for inconveniently, possible destructively high temperatures. Conveniently, the reaction time is about 20 seconds.

As discussed previously, the melt strength of the propylene polymer is advantageously increased by this coupling reaction. Preferably, the melt strength is increased to at least about 1.5, more preferably 2.0, times the melt strength of the polypropylene before coupling, most preferably at least about 3 times that of the polymer before coupling and in some instances at least 11 times that of the polymer before coupling. The melt strength is preferably at least sufficient to support a stable bubble at output rates of at least about 6 lb/hr/in of die circumference (0.298 g/s/cm) at 2 mil (50 micron) gauge, more preferably at least about 8 lb/hr/in of die circumference (0.397 g/s/cm) at 2 mil gauge, most preferably at least about 11 lb/hr/in of die circumference (0.546 g/s/cm) at 2 mil gauge, and, in some instances, at least about 14 lb/hr/in of die circumference (0.695 g/s/cm) at 2 mil gauge. Preferably, the melt strength of modified propylene polymer is up to 20 times that of the polymer before coupling, more preferably 12 or less. When excessive levels of coupling agents are used, one can experience gels, poor drawability (insufficient to draw the film to gauges as low as 0.6 mils (15 microns)), tear-off at the die, and lower than desired mechanical properties, such as dart and tear strength.

Melt strength is measured in uniaxial conditions extensional flow at isothermal conditions. Linear chains of isotactic polypropylene do not strain harden for all molecular weights reported in literature. In contrast, homopolymer and random copolymer chain-coupled isotactic polypropylene chains strain harden strongly as indicated by a rise in the viscosity η_{E+} by a factor of 10-100 when characterized under the same conditions. Surprisingly, the impact copolymer polypropylene resins used by us do not strain harden on coupling when characterized under the same condition.

### Ethylene Polymers

The modified polypropylene may be blended with various ratios of at least one ethylene polymer, preferably linear low density polyethylene (LLDPE), substantially linear polyethylene, or a homogeneously branched linear polyethylene, to provide enhanced mechanical properties. Optionally, but not in the most preferred embodiment, the ethylene polymers have monomers having at least two double bonds which are preferably dienes or trienes. Suitable diene and triene comonomers include 7-methyl-1,6-octadiene, 3,7-dimethyl-1,6-octadiene, 5,7-dimethyl-1,6-octadiene, 3,7,11 -trimethyl- 1,6,10-octatriene, 6-methyl-1,5-heptadiene, 1,3-butadiene, 1,6-heptadiene, 1,7-octadiene, 1,8-nonadiene, 1,9-decadiene, 1,10-undecadiene, norbornene, tetracyclododecane, or mixtures thereof, preferably butadiene, hexadienes, and octadienes, most preferably 1,4-hexadiene, 4-methyl-1,4-hexadiene, 5-methyl-1,4-hexadiene, dicyclopentadiene, and 5-ethylidene-2-norbornene. These monomers are optionally used with ethylene alone or, preferably, with ethylene and at least one additional monomer polymerizable therewith, most preferably propylene as in the case of ethylene/propylene/diene rubber (EPDM). The comonomer content is preferably less than about 50, more preferably 2-30, most preferably 5-20 weight percent.

The polymer starting materials are suitably of any molecular weight distribution (MWD). MWD is calculated as the ratio M_{w}/Mₙ, where M_{w} is the weight average molecular weight and Mₙ is the number average molecular weight. Those skilled in the art are aware that polymers having a MWD less than about 3 are conveniently made using a metallocene or constrained geometry catalyst (especially in the case of ethylene polymers) or using electron donor compounds with Ziegler Natta catalysts (especially in the case of polypropylene). In the practice of the invention, the MWD is preferably at least about 2 and more preferably up to about 8, most preferably up to about 5.

The ethylene polymers preferably have a melt index (MI) as measured by ASTM D-1238 condition 190° C./2.16 Kg (formerly known as Condition E) sufficient to support a 2 mil (50 micron) blown film bubble, preferably at least about 0.1 g/l 0 min., more preferably at least about 0.5 g/10 min. The MI is preferably less than 15, more preferably less than about 10, most preferably less than about 6 g/1 0 min.

The ethylene polymers preferably have a density at least about 0.865 g/cm³as measured by ASTM D 792, more preferably at least about 0.87 g/cm³, most preferably at least about 0.88 g/cm³. Preferably, the density is less than 0.96, more preferably up to about 0.95, most preferably up to about 0.930 g/cm³. Most preferably, the ethylene polymer is linear low density polyethylene (LLDPE), a substantially linear polyethylene, or a homogeneously branched linear polyethylene. Substantially linear polyethylene is that polyethylene described in U.S. Pat. Nos. 5,373,236 and 5,278,272 which are incorporated by reference herein in their entireties. Examples of a homogeneously branched linear polyethylene are polyethylenes having a CDBI greater than 50% as calculated in accordance with WO 93/ 04486 using the equipment and procedures as described in U. S. Pat. No. 5,008,204, such as polyethylenes available from the Exxon Chemical Company under the trade names EXCEED and EXACT. Ethylene polymers suitable for practice of the invention include polymers such as those commercially available from The Dow Chemical Company under the trade designations DOWLEX, AFFINITY and ELITE polyethylenes; polymers commercially available from Exxon Chemical Corporation under the trade designation EXACT and EXCEED and polymers commercially available from Mitsui Petrochemical Industries under the trade designation TAFMER. More specifically preferred polyethylenes include such polymers as polyethylene commercially available from The Dow Chemical Company under the trade designation DOWLEX 2045 polymer and polyethylene commercially available from Equistar, Inc. under the trade designation Petrothene GA501020 polymer.

In an alternative embodiment, the polyethylene is preferably a high density polyethylene, more preferably having a density of at least about 0.940 g/cm³. Most preferably the density is between about 0.940 and 0.962 g/cm³, inclusively. The high density polyethylene preferably has a molecular weight at least about 100,000 and is of the type referred to in the art as high molecular weight, high density polyethylene (HMWHDPE). More preferably the molecular weight is between about 150,000-300,00 inclusively. Such polyethylenes are within the skill in the art, for instance, as commercially available from Equistar, Inc. under the trade designation HDPE 5005 polymer or from The Dow Chemical Company under the trade designation High Density Polyethylene 53050E.

Melt or dry blending, e.g. at the hopper of the extruder or in an off-line tumble blending operation, is useful to achieve the blends of the invention. The ethylene polymer is advantageously observed to increase the film properties such as tear resistance in both the machine direction (MD) and cross direction (CD) as measured by Elmendorf Tear (ASTM D-1922), dart impact as measured by ASTM D- 1709 or a modified method thereof in which the height from which the dart falls is decreased from 26″ to 10.5″ (0.66 m to 0.27 m) as compared with a film formed in the same manner using the coupled propylene polymer(s) alone. Preferably, a sufficient amount of ethylene polymer is used to increase at least one of the film properties of a film made of the blend by at least about 20%. more preferably by at least about 50%, most preferably by at least about 100% compared with the film properties of a film formed in a similar manner using the coupled propylene polymer alone.

Preferably, the amount of ethylene polymer is at least about 5 percent, more preferably about 10 percent, most preferably at least about 15 percent of the resulting blend of coupled polypropylene and polyethylene. At amounts of ethylene polymer of preferably less than 50 percent, more preferably less than about 40 percent, most preferably less than about 35 percent or less, films of acceptable film stiffness can advantageously be obtained at relatively low cost. An acceptable film stiffness is a stiffness measured by secant modulus (ASTM D882) sufficient to allow feeding of film into bag making equipment at convenient and acceptable rates by one skilled in the art.

In the alternative embodiment where high molecular weight, high density polyethylene is admixed with the coupled polypropylene, the polyethylene is preferably used in an amount corresponding to at least about 5 percent by weight, more preferably at least about 10 weight percent, most preferably at least about 15 weight percent of the resulting blend. The polyethylene is used to increase the tear resistance of a film made from the blend as compared to that of a film made from the polypropylene alone. The amount of polyethylene is preferably less than about 40, most preferably less than about 30 weight percent of the resulting blend with the coupled polypropylene. As compared to the use of a lower density polyethylene, use of the same amount of a high density, high molecular weight polyethylene in a blend with the same proportion of coupled polypropylene results in a film having higher modulus as measured according to the procedures of ASTM 882.

Those skilled in the art will recognize that more than one ethylene polymer is optionally used, particularly when each polymer contributes a desirable characteristic to the blend or resulting film or other article. Similarly, more than one propylene polymer is optionally included in a blend of the invention. At least one of the propylene polymers is coupled in the practice of the invention; however, coupling of one or more other polymers included in the blend is optional. Furthermore, polymers other than ethylene polymers and propylene polymers are optionally included with the at least one coupled propylene polymer and at least one ethylene polymer in blends of the invention.

### Film Forming

Compositions of the invention are advantageously useful in making films, especially blown films. The technique of blown film extrusion is well known for the production of thin plastic films. In an advantageous process, plastics, such as low, linear low, and high density polyethylene (LDPE, LLDPE, and HDPE) are extruded through a circular die to form a film. Air is introduced through the center of the die to maintain the film in the form of a bubble which increases the diameter of the film about 2 to 6 fold, after which the bubble is collapsed onto rollers. There are a number of variations of such a process within the skill in the art, for instance as described in such references as U.S. Pat. Nos. 3,959,425; 4,820,471, where the difference between high (referred to as “long stalk” therein) and low stalk film blowing is discussed at column 1; 5,284,613; W. D. Harris, et al in “Effects of Bubble Cooling on Performance and Properties of HMW-HDPE Film Resins”, Polymers. Laminations & Coatings Conference, Book 1, 1990, pages 306-317; and, Moore, E. P., Polypropylene Handbook, Hanser, N.Y., 1996, pages 330-332. Most references to blowing polyolefin films disclose processes used for polyethylene, but these are applicable to the blends of the invention with few modifications within the skill in the art without undue experimentation. For instance, cooling is often advantageously modified because the art recognizes that polypropylene cools and crystallizes at a rate different from that of polyethylene. Therefore, adjustments to the cooling parameters often produce a more stable bubble at desired output rates.

In the formation of blown films, a melt enters a ring-shaped die either through the bottom or side thereof. The melt is forced through spiral grooves around the surface of a mandrel inside the die and extruded through the die opening as a thick-walled tube. The tube is expanded into a bubble of desired diameter and correspondingly decreased thickness as previously described.

Two primary types of blown film equipment are of particular interest for making films of the invention. One type is identified in the art with the making of low density and linear low density polyethylene films. This type is characterized by low stalk height (die to frost line distance of about 2-6 die diameters), and a single screw extrusion using an annular die with die gaps measuring from 30-120 mils (750-3050 microns). This equipment is particularly useful for polymers having characteristics of: (a) higher melt strength, that is melt strength above about 1 cN; (b) good drawability, that is the ability to be stretched to as thin as 0.5 mils (13 microns); and, (c) good processability, that is the ability to maintain a stable bubble at outputs rates of greater than 10 lbs/hr/inch (0.496 g/s/cm) of die circumference. Examples of equipment used in this process are produced by Battenfeld Gloucester, Inc., Davis-Standard Equipment, or Black-Clawson.

A second type of equipment is identified in the art with the making of high molecular weight high density polyethylene films. This type is characterized by a high stalk height (die to frost line distance of 5-15 die diameters). This equipment is particularly useful for polymers having characteristics of high molecular weight (that is melt index (15) less than about 0.5 g/l 0 minutes at 190° C. and 5 kg), and a need for longer cooling and relaxation times than LLDPE. Examples of this type of equipment are produced by Alpine, Inc. or Kiefel.

Surprisingly, blown films of the invention are advantageously produced on both high and low stalk types of equipment.

Preferably, compositions of the invention are optionally blown on the first type of equipment (i.e., low stalk) at rates of at least about 6 lb/hr/in of die circumference (0.298 g/s/cm of die circumference), more preferably at least about 8 lb/hr/in of die circumference (0.496 g/s/cm of die circumference), most preferably at least about 10 lb/hr/in of die circumference (0.695 g/s/cm of die circumference).

The second type of film blowing equipment (i.e., high stalk) is commonly used for blowing films from high molecular weight-high density polyethylene (that is polyethylene having a melt index (I₅). of at least about 0.5 g/10 min and a density of at least about 0.940 g/ml).

The formation of coextruded blown films is known in the art and applicable to the present invention. Articles illustrative of the art include Han and Shetty, “Studies on Multilayer Film Coextrusion III. The Rheology of Blown Film Coextrusion.” Polymer Engineering and Science, February, (1978), vol. 18, No.3 pages 187-199; and Morris, “Peel Strength Issues in the Blown Film Coextrusion Process,” 1996 Polymers, Laminations & Coatings Conference, TAPPI Press, Atlanta, Ga. (1996), pages 571-577. The term “coextrusion” refers to the process of extruding two or more materials through a single die with two or more orifices arranged such that the extrudates merge together into a laminar structure, preferably before chilling or quenching. Coextrusion systems for making multilayer films employ at least two extruders feeding a common die assembly. The number of extruders is dependent upon the number of different materials comprising the coextruded film. For each different material, a different extruder is advantageously used. Thus a five-layer coextrusion may require up to five extruders although less may be used if two or more of the layers are made of the same material.

Coextrusion dies are used to form coextruded blown films. They have multiple mandrels that feed the different melt streams to the circular die lip. When feedblocks are employed to stack melt layers from two or more extruders, the resulting multilayered melt stream is then fed to the film die.

Coextruded blown films of the present invention can be formed into pouches, bags, containers and the like using packaging machinery within the skill in the art such as heat sealing devices using mandrels and the like. Pouches, bags and other containers made from this combination of materials provide excellent toughness and impact strength and furthermore provide an excellent barrier to grease and oil and light hydrocarbons such as turpentine and the like. Coextruded blown film of the present invention can be used as a packaging substrate alone, as a liner in multi-wall bags, or a strength/sealant ply in laminated structures such as with polyethylene terephthalate or biaxially oriented polypropylene.

In multilayer films each layer advantageously imparts a desired characteristic such as weatherability, heat seal, adhesion, chemical resistance, barrier layers (e.g. to water or oxygen), elasticity, shrink, durability, hand and feel, noise or noise reduction, texture, embossing, decorative elements, impermeability, stiffness, and the like. Adjacent layers are optionally direct adhered, or alternatively have an adhesive, tie or other layer between them, particularly for the purpose of achieving adhesion therebetween. Constituents of the layers are selected to achieve the desired purpose.

In one aspect of the invention where toughness, optics, and/or heat seal performance are important, coextruded films employing a propylene polymer coupled using poly(sulfonyl azide) in one layer of such a multilayer film and an ethylene polymer is used in at least one other layer. The ethylene polymer layer will improve the overall toughness of the film structure. The coupled propylene polymer may comprise an impact copolymer, a random copolymer or a homopolymer of propylene. The polymer blends previously described and described hereinafter for use in monolayer films, may be used for one layer of a multilayer film. It is believed that ethylene polymers blended with the coupled propylene polymer will improve the compatibility of the propylene polymer and the ethylene polymer film layers for one another in the multilayer film structure. The ethylene polymer may comprise LLDPE, LDPE, HDPE, substantially linear polyethylene, homogeneously branched linear polyethylene, and blends thereof. In one preferred aspect of the invention, a three layer film structure is used with a coupled propylene polymer as described herein, used for the core layer. This core layer may optionally contain ethylene blended with the propylene polymer. This core layer is sandwiched between two ethylene polymer skin layers. These skin layers may be comprised of LDPE, LLDPE, HDPE, substantially linear polyethylene, homogeneously branched linear polyethylene, and blends thereof.

Films made of the compositions of the invention advantageously have greater resistance to tear and puncture than films of the same gauge made by the same process but from the same coupled propylene polymer(s) without the ethylene polymer. Preferably, films of the invention have a machine direction tear resistance (MD tear) as measured according to the procedures of ASTM D1922 of at least about 5 g/mil (0.2 g/micron) preferably at least about 7.5 g/mil (0.3 g/micron), a cross directional tear resistance (CD tear) as measured according to the procedures of ASTM D1922 of at least about 20 g/mil (0.8 g/micron preferably at least about 50 g/mil (2 g/micron). Surprisingly, blown films according to the current invention can be produced at higher output rates, higher haul-off rates, thinner film thicknesses, or a combination thereof.

Blown films comprising the propylene polymer/ethylene polymer blend according to the current invention have surprisingly been found to have better anti-blocking characteristics than blown films made with either polymer alone.

Films made of the compositions of this invention advantageously have greater heat seal strength than films of the same gauge made from the same propylene polymers and ethylene polymers but without the coupling process.

### Additives

Additives are optionally included in compositions of the invention. Additives are well within the skill in the art. Such additives include, for instance, stabilizers including free radical inhibitors and ultraviolet wave (UV) stabilizers, neutralizers, nucleating agents, slip agents, antiblock agents, pigments, antistatic agents, clarifiers, waxes, resins, fillers such as silica and carbon black and other additives within the skill in the art used in combination or alone. Effective amounts are known in the art and depend on parameters of the polymers in the composition and conditions to which they are exposed.

### Uses

These films are advantageously used to make institutional liners, that is liners (or trash bags) for trash cans used in industry. Characteristics useful in these liners are good tear, (dart) impact strength, puncture strength, and high modulus. The term “good” is used to indicate tear above about 5 g in the MD and 10 g in the CD measured by the tests listed in the previous paragraph, impact strength above about 30 g/mil as measured by the modified procedure of ASTM D1709 condition A as described previously. The term “high modulus” is used to mean secant modulus as measured by ASTM D 882 of at least about 40,000 psi (275,790 kPa). The liners and similar products are made for instance by processes within the skill in the art such as those disclosed by C. A. van Kerckhoven, et al, “Quality Performance Optimization Tools for the Fabrication of HMW-HDPE Blown Film”, Polymers, Laminations, & Coatings Conference, Book 2, 1990, pages 68-85.

The present invention includes but is not limited to use of the films of the invention in such applications as consumer liners, heavy duty shipping sacks, produce bags, batch inclusion bags, pouches, grocery bags, merchandise bags, bags for foam packaging (especially where the foam is formed in the bag), cereal liners, soft paper overwrap, multi-wall bags, baler bags, bundling films, compression films and laminations.

Films of the current invention are also useable as heat seal films, pouches or bags.

### EXAMPLES

The following examples are to illustrate this invention and do not limit it. Ratios, parts, and percentages are by weight unless otherwise stated. Examples (Ex) of the invention are designated numerically while comparative samples (C.S.) are designated alphabetically and are not examples of the invention.

The oxy bis(4-sulfonyl azide) benzene is prepared by the reaction of sodium azide with the corresponding bis(sulfonyl chloride) which is commercially available. An aqueous solution of sodium azide is added to an acetone solution of the bis(sulfonyl chloride), and the product is isolated by precipitation with excess water.

### Comparative Samples A: Films from Random Propylene Copolymers

a. Preparation of Coupled Isotactic Polypropylene

Isotactic polypropylene pellets (commercially available from Montell NA under the trade designation Profax SA861, which is a random copolymer of propylene and 2.5 weight percent of ethylene, melt flow rate (MFR)=6.5 dg/min (230° C./2.16 kg)(ASTM D1238), commercially available from Montell USA Inc. is referred as Comparative Sample A:A.

A 90800g sample of C.S. A:A was tumble blended with 2000 ppm of mineral oil at room temperature for 30 minutes followed by tumble blending with 1000 ppm each of phenolic and phosphite antioxidants commercially available from Ciba Geigy Corp. under the trade designations Irganox 1010 and Irgafos 168, respectively, and 200 ppm of oxy-bis(4-sulfonyl azide) benzene (hereinafter in the examples of this invention referred to as BSA) for an additional 30 minutes at room temperature. The resulting admixture was then fed into a 40 mm twin screw extruder with a temperature profile of 170, 180, 190, 200, 200, 210, 220, 230, 240, 240, and 240° C. from the rear to the front of the extruder. The extruder had a die temperature of 240° C. to ensure the full reaction of the BSA and propylene polymer. The resulting melt-extruded polymer strand was run through a water cooling bath (at 19° C.) before it was pelletized by a pelletizer commercially available from Sheer Bay of Bay City, Mich. under the trade designation Sheer Pelletizer (Model #SGS 100E). The output rate for this extrusion and pelletizing processes is about 200 pounds/hr (90.8 kg/hr). The resulting coupled material is referred to herein as the Comparative Sample A:B.

The procedure of Comparative Sample A:B was repeated except that 400 ppm BSA was used instead of 200 ppm BSA. This 400 ppm BSA coupled resin is referred to herein as the Comparative Sample A:C.

b. Blowing of Film in LD/LLDPE Extruder

The resulting resins were then separately and independently fed to a blown film extruder having a screw diameter 2.5 inches (6.35 cm), 6 inches (15.24 cm) in die diameter, with a die gap of 30 mil (750 micron), die temperature about 440° F. (226.7° C.), and blow up ratio (BUR) of 3.5. commercially available from Macro Engineering Company under the trade designation DC2900 and otherwise used according to manufacturer's directions. This blown film equipment is referred to herein as “LDPE/LLDPE” because it is commonly used to blow film from low or linear low density polyethylene. The extruder is 152.4 cm long and is kept at a temperature greater than 170° C.,. The so called “hump style temperature” profile (which means that the temperature is higher in the compressing section than both feed and metering sections) is used with a temperature of 190° C. in the feeding section, 225° C. in the compressing section and 215° C. in the metering section.

The resulting films are 0.35 mil (8.8 micron) gauge films were fabricated with random copolymer polypropylene Comparative Sample A:A, Comparative Sample A:B and Comparative Sample A:C at 3.5 BUR. The maximum output rates for each are 8.6 lb/h/in of die circumference (0.427 g/s/cm ), 10.6 lb/h/in (0.527 g/s/cm), and 13.3 lb/h/in (0.658 g/s/cm) of die circumference for Comparative Samples A:A, A:B, and A:C, respectively, as shown in Table 2. Comparative Samples A:A, A:B and A:C demonstrate that the blown film extrusion output in the LD/LLDPE blown film line increased from a low rate of 8.6 lb/hr into a more commercially effective rate after reaction with 400 ppm of BSA.

### Comparative Samples B: Films Formed from Propylene Impact Copolymer

### Preparation of Resins

The preparation of coupled isotactic polypropylene procedure of Comparative Sample A:B was repeated except that an impact copolymer of propylene and 9 weight percent of ethylene, melt flow rate (MFR)=2 dg/min (230° C./2.16 kg) (ASTM 1238, condition D at 230° C.) commercially available from The Dow Chemical Company under the trade designation INSPiRE C105-02 (and referred to herein as Comparative Sample B:A) was used instead of the polymer used in C.S. A:B and 350 ppm BSA was used instead of 200 ppm BSA. The resulting polymer coupled using 350 ppm BSA is herein referred as Comparative Sample B:B having the properties shown in Table 2.

### Blowing of Films with High Stalk HDPE Extruder

The resulting resins were then fed to blown film equipment that is commonly used for high molecular weight high density polyethylene (HDPE), in place of the LDPE/LLDPE type of equipment used in Example 1. The equipment has a screw diameter 2 inches (50 mm), 6 inches (250 mm) in die diameter, die gap of 40 mil (1000 microns), die temperature about 425° F. (218.3° C.), and a blow up ratio (BUR) of 3.5. The equipment is commercially available from Alpine, Inc under the trade designation model #HS50R and is designated in the table as “HDPE.”

The resulting 1.0 mil (25 micron) gauge films were fabricated using 2 MFR impact copolymer polypropylene polymer (Comparative Sample B:A), and Comparative Sample B:B at 3.5 BUR. The blown film extrusion rate for Comparative Sample B:B is 6.37 lb/h/in (0.316 g/s/cm) of die circumference in this high stalk line. However, it was not possible for Comparative Sample B:A to form a stable bubble at 4.24 lb/h/in (0.211 g/s/cm) of die circumference, as shown in Table 2. The 4.24 lb/h/in of die circumference is the minimum output rate that this extruder can deliver. Comparative Sample B demonstrated that reaction of the polymer of C.S. B with 350 ppm of BSA greatly increases the effective film fabrication rate in the high stalk HDPE blown film line.

### Comparative Samples C: Effects of Blending Polyethylene with a Propylene Homopolymer

a. On-line Blending

A homopolymer polypropylene commercially available from Montell USA Inc. under the trade designation Pro-fax H300-02Z has a melt flow rate of 2.0 dg/min (230° C./2.16 kg) [ASTM D1238 ], is referred to herein as Comparative Sample C:A. Pellets of C.S. C:A were vacuum conveyed into one of the feeders in the LD/LLDPE extruder described in C.S. A by a vacuum pump via a flexible hose. Pellets of a linear low density polyethylene commercially available from The Dow Chemical Company under the trade designation DOWLEX 2045 having a melt flow rate (MFR according to the procedure of ASTM 1238, condition D of 3.0, a flex modulus (according to the procedure of ASTM D790A of 26000 psi (1.79×10⁵ kPa) an Izod impact strength according to ASTM D256A of “no break” and a melt strength according to the procedures of ASTM D 3568 #2of 4.0 cN (centiNewtons), were conveyed into the hopper in the LD/LLDPE extruder by vacuum pump via flexible hose. Controlled by electronic device, 85 percent of C.S. C:A and 15 percent of the polyethylene were gravitically fed from the hopper into the extruder. The resulting blend is referred to herein as Comparative Sample C:B. The same polyethylene is used in each instance where a polyethylene is used in any subsequent Comparative Samples or Examples unless stated otherwise.

The procedure of C.S. C:B is repeated using 25 weight percent of the same polyethylene and 75 percent of the same polypropylene as in C.S. C:B. and the resulting blend is referred to herein as Comparative Sample C:C.

The blown film line used in this Comparative Sample is the same as the one that was described in Comparative Sample A. Films were fabricated with these three resins at 3.5 BUR, 120 lb/h of output rate (54.54 kg/h) and 0.75 mil (17.5 micron) gauge. Selected properties for these films are listed in Table 3. It can be seen from Table 3 that film properties are greatly improved by adding 25 percent of polyethylene. The data in Table 3 demonstrates the result of blending polyethylene with a polypropylene homopolymer on film properties.

### Comparative Sample D: Effects of Blending Polyethylene with a Random Propylene Copolymer

The procedure of Comparative Sample C was repeated except that a random copolymer commercially available from Montell USA, Inc. under the trade designation Pro-fax SR-256M (designated C.S. D:A herein) having properties described in C.S. D:A was used instead of C.S. C:A. Selected properties of C.S. D:A are presented in Table 3 for the resulting films. It can be seen from the data in Table 3 that both MD- and CD-tear and dart impact strength have been significantly improved after blending 25 percent of the polyethylene used in C.S. C. This demonstrates the effect on film properties of blending -polyethylene with a random propylene copolymer.

### Comparative Sample E: Effects of Blending Polyethylene with an Impact Propylene Copolymer

The procedure of Comparative Sample C was repeated except that an impact copolymer commercially available from The Dow Chemical Company under the trade designation INSPiRE C105-02 (designated C.S. E:A) having properties described in C.S. B:A was used instead of C.S. C:A. Selected properties are presented in Table 3 for the resulting films. It can be seen from the Table that both MD- and CD-tear strength have been significantly improved after blending 25 percent polyethylene with the impact propylene copolymer.

### Example 1 and Comparative Sample F: Films of Blends of Coupled Polypropylene and Polyethylene

The preparation of coupled isotactic polypropylene procedure described in Comparative Sample A was repeated except that a random copolymer polypropylene commercially available from Montell USA Inc. under the trade designation Pro-fax SR-256M having properties of in Table I was used instead of the polypropylene of C.S. A and the BSA level was 500 ppm instead of 200 ppm. The resulting coupled polypropylene is referred to herein as Comparative Sample F. A portion of the C.S. F material was blended with the polyethylene used in C.S. C in an amount corresponding to 25 percent of the resulting blend using the on-line blending method described in Comparative Sample C and is referred to herein as the Example 1. These two materials C.S. F and Ex 1 were fabricated with LD/LLDPE blown film equipment as described in Comparative Sample A. Selected properties for these films are listed in Table 4. It can be seen from Table 4 that adding 25 percent of polyethylene significantly improves dart impact, tear and puncture resistances demonstrating the effect on the film properties of adding polyethylene to coupled random copolymer polypropylene film made on LD/LLDPE blown film equipment.

### Example 2 and Comparative Sample G: Films of Blends of Coupled Impact Copolymer Polypropylene and Polyethylene

The preparation of coupled isotactic polypropylene procedure described in Comparative Sample A was repeated except that the impact copolymer polypropylene used in C.S. B was used instead of the polypropylene of C.S. A and the BSA level was 300 ppm instead of 200 ppm. The resulting coupled polypropylene is referred to herein as Comparative Sample G. A portion of the C.S. G material was blended with the polyethylene used in C.S. C in an amount corresponding to 15 percent of the resulting blend using the on-line blending method described in Comparative Sample C and is referred to herein as the Example 2. In that method. 42.5 lbs (19.3 kg) of Comparative Sample G material and 7.5 lb (3.4 kg) of the polyethylene of C.S. C were weighted and put into a plastic drum liner which was then placed in a 30 gallon fiber drum such that there is a void space to allow free tumbling of the contents. The fiber drum was then placed in a mechanical blender and tumble blended for 30 minutes at room temperature. The resulting material is a mixture of C.S. G with 15 percent of polyethylene and is referred to herein as Example 2.

Samples of C.S. G and Ex 2 were separately and independently fed by vacuum conveying to a blown film extruder having a screw diameter 2.0 inches (5.08 cm), 3 inches (7.62 cm) in die diameter, with a die gap of 30 mil (750 micron), die temperature about 440 F. (226.7° C.), and blow up ratio (BUR) of 3.0, commercially available from Egan Corporation under the trade designation model B00G345. This blown film equipment is referred to herein as “LDPE/LLDPE” equipment because it is commonly used to blow film from low or linear low density polyethylene. The extruder is 121.9 cm long and is kept at a temperature greater than 170° C. The so called “hump style temperature” profile used with a temperature of 190° C. in the feeding section, 225° C. in the compressing section and 215° C. in the metering section. The output rate was 2.65 lb/h/in (0.132 g/s/cm) of die circumference. Selected properties for these films are listed in Table 4. It can be seen from Table 4 that adding 15 percent of polyethylene significantly improves dart impact, tear and puncture resistances demonstrating the effect on the film properties of adding polyethylene to coupled impact copolymer polypropylene film made on LD/LLDPE blown film equipment.

### Example 3 and Comparative Samples H and I: Films of Blends of Coupled Impact Copolymer Polypropylene and Polyethylene

The preparation of coupled isotactic polypropylene procedure described in Comparative Sample A was repeated except that the polypropylene used in C.S. B was used instead of the polypropylene used in C.S. A and the BSA level was 500 ppm instead of 200 ppm. The resulting coupled material is referred to herein as Comparative Sample H. A portion of the Comparative Sample H material was blended with the polyethylene used in C.S. C and the polypropylene used in C.S. B by the on-line blending method as described in Comparative Sample C. The resulting material has a composition of 64 percent Comparative Sample H, 20 percent Comparative Sample B:A, and 16 percent polyethylene and is referred to herein as Example 3 (the ratio of C.S. H/C.S. B:A is 76/24). Another portion of Comparative sample H was blended with 24 percent C.S. B:A by the on-line blend method. The resulting material has a composition of 76 percent Comparative Sample H and 24 percent Comparative Sample B:A. and is referred to herein as Comparative Sample I. in Table 4 the amount of BSA is listed as 380 ppm which is the concentration based on the weight of both propylene polymers even though one propylene polymer (C.S. H) was treated with 500 ppm BSA and the other (C.S. B:A) was not coupled with BSA. Similar averaging was done to represent the other examples with more than one propylene polymer listed in Table 4.

These two materials (Ex 3 and C.S. I) were fabricated separately and independently using the LD/LLDPE blown film equipment as described in Comparative Sample C. Selected properties for these films are listed in Table 4. It can be seen from Table 4 that adding 16 percent of polyethylene significantly improves tear and puncture resistances. This example demonstrates the effect on the film properties adding polyethylene to coupled impact copolymer polypropylene in film made using LD/LLDPE blown film equipment.

### Example 4 and Comparative Sample J: Films of Blends of Coupled Impact Copolymer Polypropylene and Polyethylene

A portion of the Comparative Sample H material (as prepared by the procedure of Example 3) was blended with the polyethylene used in C.S. C and C.S. B:A by the tumble blending method as described in Example 2. The resulting material has a composition of 64 percent Comparative Sample H, 20 percent Comparative Sample B:A and 16 percent polyethylene and is referred to herein as the Example 4 (the ratio of C.S. H/C.S. B:A is 76/24). Another portion of Comparative Sample H was blended with 24 percent of the polypropylene C.S. B:A by the tumble blending method. The resulting material has a composition of 76 percent Comparative Sample H and 24 percent Comparative Sample B:A and is referred to herein as the Comparative Sample J.

The materials of Ex 4 and C.S. J were fabricated using a high stalk HDPE blown film as described in Comparative Sample B. Selected properties for these films are listed in Table 4. It can be seen from Table 4 that adding 16 percent of polyethylene improves tear resistance. This example demonstrates the effect on the film properties of adding polyethylene to coupled impact copolymer polypropylene in film formed using high stalk HDPE blown film equipment.

### Examples 5-7 and Comparative Samples K: Output Rate Comparisons

Blown film was fabricated on a Gloucester blown film line comprised of the following collection of equipment:

2.5 in. 24:1 L/D extruder

2.5 in. diameter, single flight, double mixing section screw

6 in. diameter, Gloucester die, with 40 mil die pin.

Saturn dual lip air ring

Tower, nip rolls, Gloucester dual turret winder.

Blow-up-ratio is 2.5: 1, giving a layflat width of 23.5 in.

Film was produced from Montell 7723, a 0.8 dg/min (230° C./2.16 kg), propylene impact copolymer, procured from Montel. Fabrication conditions included:

Screw speed of 67.7 rpm

Output rate of 120 lb/hr

Melt temperature of 480 F.

Extruder back pressure of 4650 psi.

At these conditions, the haul-off rate was increased as far as possible to reduce the thickness of the film and to determine the minimum thickness or maximum haul-off rate at which a stable bubble could be maintained and film could be controllably fabricated. For 100% Montell 7723 (C.S. K:A), the limit was found to be 95 ft/min haul-off rate or a thickness of around 1.5 mil. At that point the bubble starts wandering around the air ring and can no longer be controlled or locked in.

A similar trial was conducted, but this time with a blend of 65% Montell 7723 and 35% of a 0.5 MI, 0.918 density ethylene-octene copolymer, produced using a Ziegler-Natta catalyst system (C.S. K:B). The minimum thickness for the blend was about 1.3 mils.

A 0.8 MFR propylene impact copolymer, very similar to Montell 7723, was treated with 200 ppm BSA (EX. 5). This rheology-modified resin was fabricated into film under similar conditions on the same equipment as the above trial. Fabrication conditions included:

Screw speed of 69 rpm

Output rate of 120.8 lb/hr

Melt temperature of 480 F.

Extruder back pressure of 3790 psi

At these conditions, the haul-off rate was increased as far as possible to reduce the thickness of the film and to determine the minimum thickness or maximum haul-off rate at which a stable bubble could be maintained and film could be controllably fabricated. For EX. 5, the maximum rate was 250 fpm and a thickness of about 0.5 mi. Much higher rates and thinner film could be achieved for EX. 5 than was possible with either C.S. K:A or K:B.

A similar trial was conducted, but this time with a blend of 65% of the resin of EX. 5 and 35% DOWLEX 2045 (1.0 MI, 0.920 density, ethylene-octene copolymer available from The Dow Chemical Company)(EX. 6). With the blend of materials, it was again possible to reach a haul-off rate of 250 ft/min. and a thickness of 0.5 mil. Conditions for this trial included:

Screw speed of 62.1 rpm

Output rate of 119.4 lb/hr

Melt temperature of 463 F.

Extruder back pressure of 3770 psi.

Likewise, a film was fabricated from a blend of 65% DP836, (a 0.5 MFR. ethylene-propylene, random copolymer (˜3.5% ethylene) produced in Safripol) and 35% of the ethylene-octene copolymer used for C.S. K:B (C.S. K:C). The bubble was very unstable and output rates had to be slowed to about 100 lb/hr. At this rate, the minimum thickness that could be obtained was approximately 2.5 mil.

Next, a sample of DP836, treated with 150 ppm BSA, blended with 35 wt. % of the ethylene-octene copolymer used for C.S. K:B was evaluated (EX. 7). Thin film down to 0.5 mil could be fabricated without difficulty.

These trials show that treatment with BSA improves the ability to fabricate thin films at high drawn-down speeds. The results of these trials are shown in Table 5.

### Examples 8-10 and Comparative Samples L and M: Blocking Comparisons

A rheology modified propylene impact copolymer was produced as described for Example 5. This modified propylene ICP was blended with an LDPE (DOWLEX 2045) in weight percentages of polypropylene of 0, 50, 70, 85 and 100% (based on the weight of the combined polymers) to form C.S. L, Example 8, Example 9, Example 10, and C.S. M, respectively. Blown film was fabricated from these blends on a Gloucester blown film line as described for Example 5. The average blocking was determined for each sample and the results are shown in Table 6. As shown in Table 6, the examples of the inventive blend of modified polypropylene impact copolymer and polyethylene had a lower average block than did either polymer alone. These results were particularly noticable at higher polypropylene weight percentages (Examples 9 and 10) where the average block was less than half the average block for either polymer alone.

### Example 11 and Comparative Sample N

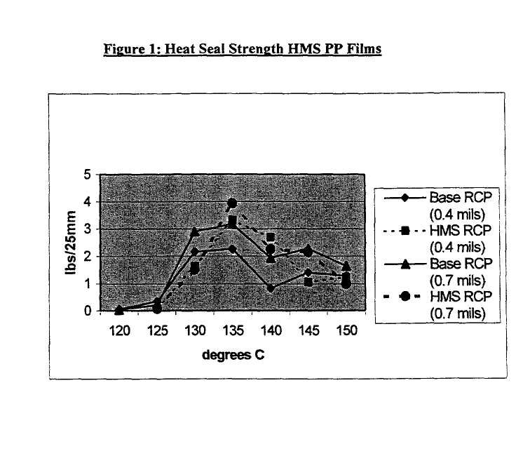

Trials were conducted comparing a base random copolymer (RCP)(PROFAX SA861, available from Montell(C.S.N)) versus a coupled high melt strength random copolymer (HMS RCP)(PROFAX SA861 coupled by reaction with 200 ppm BSA(EX. 11)). The heat seal performance of 0.4 and 0.7 ml monolayer films of the base RCP and the HMS RCP are shown in FIG. 1. Ultimate heat seal strength of the HMS RCP, in both the thin and thicker films, is approximately 25% higher than the base RCP. Similar trends are seen for homopolymers and impact copolymers.

### Example 12 and Comparative Sample O

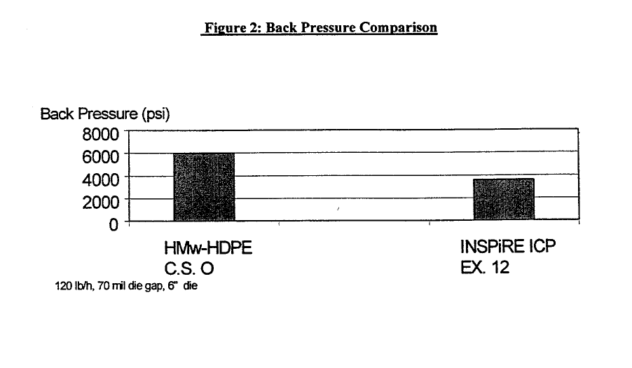

The coupled propylene polymers used in this invention provide significant processing advantages. Trials were run using a coupled propylene impact copolymer as described for Example 3. As shown in FIG. 2, the coupled propylene impact copolymer (EX. 12) provides lower back pressure than a high molecular weight high density polyethylene (C.S. O) when extruded on a linear low density polyethylene line. The trials shown in FIG. 2 were run at 120 lbs./hr. using a 70 ml. die gap with a 6 inch die.

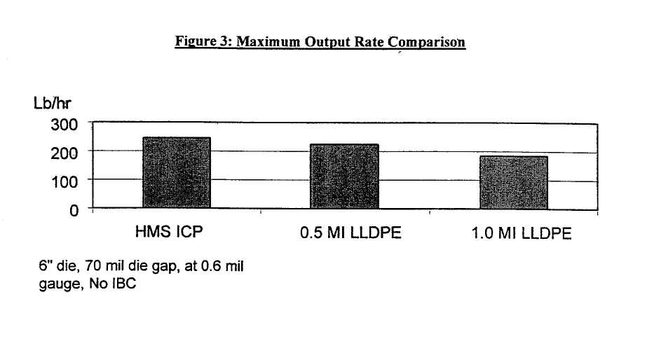

Likewise, use of coupled propylene impact copolymers provides for maximum output rates when compared against linear low density polyethylene. Trials were conducted on an LLDPE line with a 70 ml. die gap, a 6 inch die and drawing film to a 0.6 mil gauge. The maximum sustainable output rate was measured and is plotted on FIG. 3. The high melt strength ICP is the same as used for Example 3. The LLDPE is an ethylene polymer having a density of 0.920 g/cm3 and a melt index of 0.5 (available under the trade name Dowlex 61528.20).

TABLE 1
Starting Material Propylene Polymers

| | | | | | Izod Impact in | | |
|---|---|---|---|---|---|---|---|
| | | | Melt flow rate | Flex Modulus | ft-lb/in | | |
| | | | (MFR) in | psi (kPa) | (J/m) | Tensile strength | Melt Strength in |
| | | | dg/min | measured by | measured by | psi (kPa) | centiNewtons |
| | | Weight | (230° C./2.16 | the procedures | the procedures | measured by the | (cN) measured |
| | Weight | percent other | kg) by the | of ASTM | of ASTM | procedures of | by the |
| | percent | monomers | procedures of | 790A at | 256A at | ASTM 638 at | procedures of |
| Identity herein | propylene | specified | ASTM 1238 | condition D | condition D | conditon D | ASTM |
| Comparative | 97.5% | 2.5% | 6.5 | 130,000 | 1.1 | 4000 | 1.1 |
| Sample A:A | | | | (8.96E5) | (58.68) | (27,579) | |
| Comparative | 82% | 18% | 2.0 | 140,000 | No break | 3200 | 4.5 |
| Sample | | | | (9.65E5) | | | |
| B:A | | | | | | (22,060) | |
| Comparative | 100 | 0 | 2.0 | 230,000 | 0.8 (42.77) | 5000 | 4.0 |
| Sample | | | | (1.59E6) | | (34,500) | |
| C:A | | | | | | | |
| Comparative | 96.8% | 3.2% | 2.0 | 15,000 | 6.0 (320) | 4000(27,579) | 4.0 |
| Sample D:A | | | | (1.06E6) | | | |

TABLE 2
Comparative Samples Showing the Effects of Coupling on Output Rate

| | | | | | Tensile | Melt | | |
|---|---|---|---|---|---|---|---|---|
| | | | Flex Modulus | Izod Impact in | strength psi | Strength in | Type of blown | |
| | | | psi (kPa) | ft-lb/in | (kPa) | centiNewton | film equipment | |
| | | Melt flow rate | measured by | (m-kg/m) | measured by | s (cN) | used as | Maximum |
| | Ppm | (MFR) dg/min | the | measured by | the | measured by | described | output without |
| | by | (230° C./2.16 kg) | procedures of | the procedures | procedures | the | herein (HDPE | bubble |
| Identity | weight | by the procedures | ASTM | of ASTM | of ASTM | procedures | or | breaking in |
| herein | BSA | of ASTM D1238 | D790A | D256A | D638 | of ASTM | LLDPE/LDPE) | lb/hr (kg/hr) |
| Comparative | 0 | 6.5 | 130,000 | 1.1 | 4000 | 1.1 | LLDPE/LDPE | 162 (73.6) |
| Sample A:A | | | (8.96E5) | (58.68) | (27,579) | | | |
| Comparative | 200 | 4.4 | N/A | N/A | N/A | 10.5 | LLDPE/LDPE | 200 (90.9) |
| Sample A:B | | | | | | | | |
| Comparative | 400 | 2.8 | N/A | N/A | N/A | 13.5 | LLDPE/LDPE | 245 (111.4) |
| Sample A:C | | | | | | | | |
| Comparative | 0 | 2.0 | 140,000 | No break | 3200 | 4.5 | HDPE | <90 (<40.9) |
| Sample | | | (9.65E5) | | (22,060) | | | |
| B:A | | | | | | | | |
| Comparative | 350 | 0.7 | N/A | N/A | N/A | 45 | HDPE | 120 (54.5) |
| Sample | | | | | | | | |
| B:B | | | | | | | | |

TABLE 3
Comparative Samples Showing Impact of Blending Polyethylene on films

| | | | | | | | | | Type of | |
|---|---|---|---|---|---|---|---|---|---|---|
| | | | | | | | Dart impact | | blown | |
| | | | | | CD tear | | g/mil (g/m) | | film | |
| | | | | | g/mil | | measured | CD | equipment | Rate of |
| | | | | MD tear | (g/m) | CD elon- | by the | toughness ft- | used as | production |
| | | | | g/mil (g/m) | measured | gation % | procedures | lb/in³ | described | lb/hr |
| | | | | measured by | by the | measured | of ASTM | (Newton/m³) | herein | (kg/hr) at |
| | Ppm | Blended | | the | procedures | by the | D1709 at | measured by | (HDPE | 3.5 BUR |
| | by | with weight | Gauge in | procedures of | of | procedures | condition A | the | or unless | |
| | weight | percent | mil (m) | ASTM | ASTM | of ASTM | except as | procedures | LLDPE/ | noted |
| Identity herein | BSA | polyethylene | of film | D1922 | D1922 | D882 | noted | of ASTM | LDPE) | otherwise |
| Comparative | 0 | 0 | 0.75 | 6.5 | 27.4 | 11 | | 29 | LLDPE/ | 120 (54.5) |
| Sample C:A | | | | | | | | | LDPE | |
| Comparative | 0 | | 0.75 | 9.3 | 42 | 10 | | 29 | LLDPE/ | 120 (54.5) |
| Sample C:B | | 15 | | | | | | | LDPE | |
| Comparative | 0 | 25 | 0.75 | 12.9 | 130 | 670 | | 2240 | LLDPE/ | 120 (54.5) |
| Sample C:C | | | | | | | | | LDPE | |
| Comparative | 0 | 0 | 0.75 | 3.6 | 18.5 | | *139 | | LLDPE/ | 120 (54.5) |
| Sample D:A | | | | | | | | | LDPE | |
| Comparative | 0 | 15 | 0.75 | 9.9 | 28.7 | | *139 | | LLDPE/ | 120 (54.5) |
| Sample D:B | | | | | | | | | LDPE | |
| Comparative | 0 | 25 | 0.75 | 11.4 | 127 | | *199 | | LLDPE/ | 120 (54.5) |
| Sample D:C | | | | | | | | | LDPE | |
| Comparative | 0 | 0 | 0.75 | 12.3 | 32.2 | | 66 | | LLDPE/ | 120 (54.5) |
| Sample E:A | | | | | | | | | LDPE | |
| Comparative | 0 | 15 | 0.75 | 11.7 | 95.5 | | 90 | | LLDPE/ | 120 (54.5) |
| Sample E:B | | | | | | | | | LDPE | |
| Comparative | 0 | 25 | 0.75 | 19.9 | 137 | | 72 | | LLDPE/ | 120 (54.5) |
| Sample E:C | | | | | | | | | LDPE | |

TABLE 4
Examples 1-4 in films

| | | | | | | | | | Puncture ft- | Type of | Rate of |
|---|---|---|---|---|---|---|---|---|---|---|---|
| | | | | | | | Dart impact | | lb/in³ | blown | produc- |
| | | | | MD tear | CD tear | | g/mil (g/m) | | (Newton/m³) | film | tion |
| | | | | g/mil | g/mil | | measured | CD | measured by | equipment | lb/hr |
| | | | | (g/m) | (g/m) | CD elon- | by the | toughness ft- | the | used as | (kg/hr) |
| | | Blended | | measured | measured | gation % | procedures | lb/in³ | procedures of | described | at 3.5 |
| | | with | | by the | by the | measured | of ASTM | (Newton/m³) | ASTM 1709 | herein | BUR |
| | Ppm | weight | Gauge | procedures | procedures | by the | D1709 at | measured by | except that | (HDPE | unless |
| | by | percent | in mil | of | of | procedures | condition A | the pro- | the dart is | or | noted |
| Identity | weight | poly- | (mm) | ASTM | ASTM | of ASTM | except as | cedures of | dropped from | LLDPE/ | other- |
| herein | BSA | ethylene | of film | D1922 | D1922 | D882 | noted | ASTM D882 | 10.5″ (0.27m) | LDPE) | wise |
| Compara- | 500 | 0 | 1.0 | 7.7 | 13.7 | 11.0 | 66.0* | 30.0 | 70.0 | LLDPE/ | 120 |
| tive | | | (0.025) | | | | | | | LDPE | (54.5) |
| Sample F | | | | | | | | | | | |
| Example 1 | 500** | 25 | 1.0 | 14.8 | 73.9 | 690.0 | 232* | 2090.0 | 100.0 | LLDPE/ | 120 |
| | | | (0.025) | | | | | | | LDPE | (54.5) |
| Compara- | 300 | 0 | 1.0 | 4.7 | 27.1 | | 32.5 | | 81.8 | LLDPE/ | 25 lb/h |
| tive | | | (0.025) | | | | | | | LDPE | (11.36 kg/h) |
| Sample G | | | | | | | | | | | at 3.0 BUR |
| Example 2 | 300** | 15 | 1.0 | 7.9 | 45.4 | | 52.5 | | 99.4 | LLDPE/ | 25 lb/h |
| | | | (0.025) | | | | | | | LDPE | (11.36 kg/h) |
| | | | | | | | | | | | at 3.0 BUR |
| Compara- | 380*** | 0 | 1.0 | 7.3 | 29 | | 65 | | 88 | LLDPE/ | 120 lb/h |
| tive | | | (0.025) | | | | | | | LDPE | (54.5 kg/h) |
| Sample 1 | | | | | | | | | | | at 3.5 BUR |
| Example 3 | 380** | 16 | 1.0 | 17 | 48 | | 66 | | 102.5 | LLDPE/ | 120 lb/h |
| | | | (0.025) | | | | | | | LDPE | (54.5 kg/h) |
| | | | | | | | | | | | at 3.5 BUR |
| Compara- | 380** | 0 | 1.0 | 7.6 | 8.8 | | | | | HDPE | 100 lb/h |
| tive | | | (0.025) | | | | | | | | (45.45 kg/h) |
| Sample J | | | | | | | | | | | 3.5 BUR |
| Example 4 | 380** | 16 | 1.0 | 10.6 | 30.8 | | | | | HDPE | 100 (45.45 |
| | | | (0.025) | | | | | | | | kg/h) |
| | | | | | | | | | | | 3.5 BUR |

*In these instances, Dart impact strength was measured according to ASTM D1709 except the height of the dart is 10.5″ instead of 26″.
**In these instances, the amount of BSA is the amount of BSA in the polypropylene resin.
***In these instances, the amount of BSA is averaged between BSA coupled and uncoupled polypropylene resins.

TABLE 5
Output Experiments

| Base Resin | C.S. K:A | EX.5 | C.S. K:B | EX.6 | C.S. K:C | EX.7 |
|---|---|---|---|---|---|---|
| % Base Resin | 100 | 100 | 65 | 65 | 65 | 65 |
| BSA Treated ? | 0 | 200 | 0 | 200 | 0 | 150 |
| Blend Resin | | | Ethylene- | DOWLEX 2045 | Ethylene- | Ethylene- |
| | | | octene | | octene | octene |
| % Blend Resin | | | 35 | 35 | 35 | 35 |

Film Fabrication
Conditions

| | | | | | | |
|---|---|---|---|---|---|---|
| Screw Speed (rpm) | 67.7 | 69 | 67.7 | 62.1 | | |
| Output Rate (lb/hr) | 120 | 120.8 | 118.3 | 119.4 | 100 | 120 |
| Melt Temp. (F) | 480 | 480 | 480 | 463 | | |
| Back Pressure (psi) | 4650 | 3790 | 4650 | 3770 | | |
| Maximum Haul-of | 95 | 250 | ˜110 | 250 | ˜50 | 250 |
| Rate (fpm) | | | | | | |
| Maximum Thickness | 1.5 | 0.5 | 1.3 | 0.5 | 2.5 | 0.5 |
| (mil) | | | | | | |

Gloucester Blown Film Line Description:
2.5 in. 24:;1 L/D extruder
2.5 in. diameter, single flight, double mixing section screw
6 in. diameter, Gloucester die, with 40 mil die pin.
Saturn dual lip air ring
Tower, nip rolls, Gloucester dual turret winder.
Blow-up-ratio is 2.5:1, giving a layflat width of 23.5 in.

TABLE 6
Blocking Comparisons

| SAMPLE | C.S.L. | Ex. 8 | Ex. 9 | Ex. 10 | C.S.M. |
|---|---|---|---|---|---|
| Coupled Propylene | 0 | 50 | 70 | 85 | 100 |
| ICP (wt. %) | | | | | |
| Average Block | 69.24 | 8.64 | 5.04 | 5.02 | 12.5 |

These examples show that reacting BSA with polypropylene improves the blown film fabrication rate achievable, reduces the minimum gauge attainable, and/or increases the maximum haul-off rate or line speed achievable. In addition blending polyethylene enhances the film properties regardless of the equipment used.

We claim

1. A composition comprising
(a) at least one propylene polymer coupled by reaction with a coupling amount of poly(sulfonyl azide) sufficient to increase the melt strength of the resulting coupled propylene polymer to at least about 1.5 fold that of the propylene polymer before coupling; and
(b) at least one ethylene polymer
wherein the ethylene polymer is present in an amount sufficient to improve film mechanical properties of tear resistance in either the machine direction (MD) and cross direction (CD) as measured by the Elmendorf Tear method (ASTM D-1922) or dart impact strength as measured by the procedure of ASTM D-1709 or a modified method thereof in which the height from which the dart is dropped is decreased from 26″ to 10.5″ (0.66 m to 0.27 m) as compared with a film formed in the same manner using the coupled propylene polymer of (a) alone.

2. The composition of claim 1 wherein the propylene polymer is present in an amount of greater than about 50 weight percent of the resulting composition and the ethylene polymer is present in an amount of from about 5 to about 49 weight percent.

3. The composition of claim 2 wherein the amount of ethylene polymer is from about 10 to about 40 weight percent of the resulting composition.

4. The composition of claim 3 wherein the ethylene polymer is a low density polyethylene, linear low density polyethylene, substantially linear polyethylene, homogeneously branched linear polyethylene, or a blend thereof.

5. The composition of claim 4 wherein the ethylene polymer has a density of from about 0.865 g/cm³ to about 0.96 g/cm³.

6. The composition of claim 4 wherein the ethylene polymer has a density of from about 0.88 g/cm³ to about 0.930 g/cm³.

7. The composition of claim 6 wherein the propylene polymer is a random copolymer of propylene and a comonomer.

8. The composition of claim 6 wherein the propylene polymer is an impact copolymer of propylene and at least one comonomer.

9. A blown film of a composition of any of claims 1-8.

10. The blown film of claim 9, which is a coextruded film.

11. An article comprising a film made from the composition of claim 3.

12. The article of claim 11 which is an institutional liner, consumer liner, heavy duty shipping sack, produce bag, batch inclusion bag, pouch, grocery bag, merchandise bag, packaging, cereal liner, soft paper overwrap, multi-wall bag, lamination or combination thereof.

13. The article of claim 12 having a multi-wall configuration.

14. The article of claim 12 having a multilayer configuration.

15. The composition of claim 3 which is capable of being converted into a blown film at output rates at least about 50% greater than a similar polymer composition wherein the propylene polymer is not coupled.

16. The composition of claim 3 which is capable of being converted into a blown film at film haul off rates at least about 50% greater than a similar polymer composition wherein the propylene polymer is not coupled.

17. A coextruded film comprising:
(a) at least one layer comprising at least one coupled propylene polymer coupled by reaction with a poly(sulfonyl azide) to increase the melt strength of the coupled propylene polymer to at least about 1.5 fold that of the propylene polymer before coupling; and
(b) at least one layer comprising at least one ethylene polymer.

18. The film of claim 17, having at least one core layer comprising component (a) sandwiched between at least two outer layers, wherein the outer layers comprise component (b).

19. The film of claim 17, having at least one core layer comprising component (b) sandwiched between at least two outer layers, wherein the outer layers comprise component (a).

20. The film of claim 17, which is a heat sealable film.

21. The film of claim 17, wherein component (a) is further comprised of at least one ethylene polymer.

22. The film of claim 21, wherein the at least one ethylene polymer comprising component (a) is selected from the group consisting of: LDPE, LLDPE, HDPE, substantially linear polyethylene, homogeneously branched linear polyethylene, and blends thereof.

23. The film of claim 18, wherein the at least one ethylene polymer comprising component (b) is selected from the group consisting of: LDPE, LLDPE, HDPE, substantially linear polyethylene, homogeneously branched linear polyethylene, and blends thereof.

24. The film of claim 23, wherein component (a) further comprises at least one ethylene polymer selected from the group consisting of LDPE, LLDPE, HDPE, substantially linear polyethylene, homogeneously branched linear polyethylene, and blends thereof.

25. The film of claim 24, wherein the at least one ethylene polymer comprising component (a) is LLDPE.

26. The film of claim 17, wherein the poly(sulfonyl azide) is used in an amount greater than about 0.01 and less than about 0.3 weight percent based on the total weight of the propylene polymer present.
